(19) United States
(12) Patent Application Publication
(10) Pub. No.: US 2024/0020723 A1
(43) Pub. Date: Jan. 18, 2024

(54) SYSTEM AND METHOD FOR A SMART CONNECTED DEVICE TO PLAY AND RESPOND TO A DIGITAL AD TAG WITH AN EMBEDDED VOICE APPLICATION

(71) Applicant: Say It Now Ltd., London (GB)

(72) Inventors: Norbert HORVATH, Valetta (MT); Charlie CADBURY, London (GB); Sander SIEZEN, London (GB)

(73) Assignee: Say It Now Ltd., London (GB)

(21) Appl. No.: 18/222,015

(22) Filed: Jul. 14, 2023

Related U.S. Application Data
(60) Provisional application No. 63/389,190, filed on Jul. 14, 2022.

(51) Int. Cl. G06Q 30/0242

(52) U.S. Cl. CPC G06Q 30/0242

(57) ABSTRACT

The present disclosure describes a method and a system of providing analytics for interactive digital ad tags, executing the digital ad tags on a smart connected device, and gathering data regarding the execution of the digital ad tags for an analytics server. The method includes receiving, by the smart connected device, the digital ad tags, where each digital ad tag includes a tracking uniform resource locator (URL), where the digital ad tags are received from a digital ad server. The method further includes activating the tracking URL to provide a link to the analytics server, and sending digital tag instance data to the analytics server through the link. The method further includes receiving listener inputs as a voice application instance data and sending the voice application instance data to the analytics server through the link. The digital tag instance data and voice application instance data is analysed through analytics processes.

### CROSS-REFERENCE TO RELATED APPLICATION

This application claims priority to U.S. Provisional Application Ser. No. 63/389,190 filed on Jul. 14, 2022, which is incorporated by reference herein.

### TECHNICAL FIELD

The present invention relates to a voice-enabled smart connected devices in general, and in particular, to a system and method to enable voice-enabled smart connected devices to execute interactive audio ads comprising digital ad tags with embedded voice applications, and to respond to received voice inputs.

### BACKGROUND

Voice activated devices, such as smart speakers and smart televisions, are now prevalent in many homes. With voice activated devices, it is now possible to have interactive audio and video ads that elicit responses from listeners or the consumers of said voice activated devices. Based on the response from the listener or the consumer, additional programmed actions may be performed by the voice activated device. In addition, it may important to understand the effectiveness of any advertising via interactive audio and visual ads through voice activated devices. By determining how listeners and consumers are listening and responding to the ads, an ad creator or a marketing firm may able to adjust their interactive audio and visual ad accordingly. As such, it may important to be able to analyze quickly and efficiently the adoption rate and responsiveness to the interactive audio and visual ads, allowing for the quick turnaround of more effective audio and visual ads, and lessening the time between where ineffective audio and visual ads are provided to consumers and listeners.

Advertisements for voice-enabled smart connected devices can be allow for interaction, however currently the process of creating advertisements for voice-enabled smart connected devices does not allow for the automation required for the volume of advertising traffic found in digital (and terrestrial broadcast) environments. Custom software development may be required, along with the expertise for the creation of multiple advertisements for voice-enabled smart connected devices where a degree of automation may be desired. As part of the software development, the requirements and specifications of the advertisements needs to be collected, along with designing the flow of the advertisement, implementing functionality, and testing the code.

In addition, it may be desirable to analyze advertisements for their effectiveness and audience adoption based on a variety of factors, including, but not limited to the audience demographics and the time of day the advertisement is played. However, accessing this data and then making changes to the advertisements for voice-enabled smart connected devices is a process that may take time, and also may require custom software coding. Being able to optimize an advertisement in a short amount of time may be crucial, as not only may the aforementioned variables of audience adoption, such as audience demographics and the time of day the advertisement is played, change over time, but the time spent optimizing an advertisement is lost air time where a non-optimized advertisement is being played. As such, being able to provide an optimized advertisement in a short amount of time may be crucial. Using complicated software and the need for a software programmer elongates the time needed for optimization of an advertisement.

### SUMMARY

According to various aspects to the present invention, there is provided methods for providing analytics for an interactive digital ad tag, executing the digital ad tag on a smart connected device, and gathering data regarding the execution of the digital ad tag for an analytics server. The methods include receiving, by the smart connected device, the digital ad tag, where the digital ad tag may comprises a tracking uniform resource locator (URL), and a voice application. In a further embodiment, the digital ad tag may be received from a digital ad server. The methods further include activating the tracking URL, the tracking URL providing a link (e.g. a network link, such as, but not limited to, a hyperlink) to the analytics server. In addition, the methods may include gathering and sending a digital tag instance data to the analytics server through the link. The methods may further include executing the digital ad tag and receiving a listener input as a voice application instance data to the smart connected device, the voice application instance data comprising listener input data. The methods also include gathering and sending the voice application instance data to the analytics server through the link, wherein the digital tag instance data and voice application instance data is analysed through analytics processes.

The methods may also include performing a follow up action based on the listener input received.

The digital ad tag may include an ad marker, and the methods may also include requesting the voice application from the digital ad server upon the ad marker being played on the smart connected device.

According to various aspects to the present invention, there are also provided systems for providing analytics for an interactive digital ad tag, executing the digital ad tag, and gathering data regarding said execution of the digital ad tag. The digital ad tag may comprise a tracking uniform resource locator (URL) and a voice application. The systems include an analytics server configured to receive a digital tag instance data and a voice application instance data. The analytics server includes at least one database, the at least one database configured to store the digital tag instance data and the voice application instance data. The systems may also include a digital ad server connected to said analytics server and configured to store the digital ad tags and the voice application. The system further includes a plurality of smart connected devices connected to said analytics server and said ad server. The plurality of smart connected devices is configured to receive a digital ad tag from the digital ad server and activate the tracking URL. The tracking URL providing a link (e.g. a network link, such as, but not limited to, a hyperlink) to the analytics server. The plurality of smart connected devices is also configured to gather and send the digital tag instance data to the analytics server through the link. In addition, the plurality of smart connected devices may be configured to execute the digital ad tag and receive listener inputs as a voice application instance data to the smart connected device, the voice application instance data comprising listener input data. The plurality of smart connected devices is further configured to gather and send the voice application instance data to the analytics server through the link to be analysed.

The plurality of smart connected devices may be further configured to perform a follow up action based on the listener inputs received.

The digital ad tag may further include an ad marker, and the plurality of smart connected devices may be further configured to request the voice application from the digital server upon the ad marker being played on the plurality of smart connected devices.

The digital ad tag may include campaign information and audio files.

The voice application of the digital ad tag may include a decision tree, wherein the decision tree includes a set of logical rules for the digital ad tag.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 depicts an example system for creating and updating digital ad tags with embedded voice applications, and for voice-enabled smart connected devices to execute said digital ad tags;

FIG. 2 depicts an example client terminal from the system in FIG. 1, the client terminal configured to access a user interface or a plugin and receive inputs to create or update digital ad tags with embedded voice applications;

FIG. 3 depicts an example ad server from the system in FIG. 1, the ad server configured to create or update digital ad tags with embedded voice applications;

FIG. 4 depicts an example analytics server from the system in FIG. 1, the analytics server configured to receive and store digital ad tag instance data and voice application instance data;

FIG. 5 depicts an example digital ad tag to be provided to the voice-enabled smart connected device;

FIG. 6 depicts an example method of creating or updating a digital ad tag with a newly created voice application;

FIG. 7 depicts an alternate example method of creating or updating a digital ad tag with a templated voice application;

FIG. 8 depicts an example method of executing digital ad tags with embedded voice applications in the system of FIG. 1;

FIG. 9 depicts a continuation of the example method of executing digital ad tags with embedded voice applications of FIG. 8;

FIG. 10 depicts a continuation of the example method of executing digital ad tags with embedded voice applications of FIG. 8 and FIG. 9; and

FIG. 11 depicts an example portion of an XML schema that is used as part of a voice application.

### DETAILED DESCRIPTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

It should also be appreciated that the present invention can be implemented in numerous ways, including as a process, a method, an apparatus, a system, a device, or a method.

A person skilled in the relevant art will understand that the term “ad” refers to “advertisement”. Ad or advertisement as used herein refers to any advertisement, preferably a digital ad, more preferrably a digital audio ad. In a preferred embodiment, the advertisement may be interactive in that it has components which ask or pose a question or other content to a consumer and the consumer may provide a response. The response may be audio or other (e.g. keyboard or “touch screen” selection), more preferrably audio.

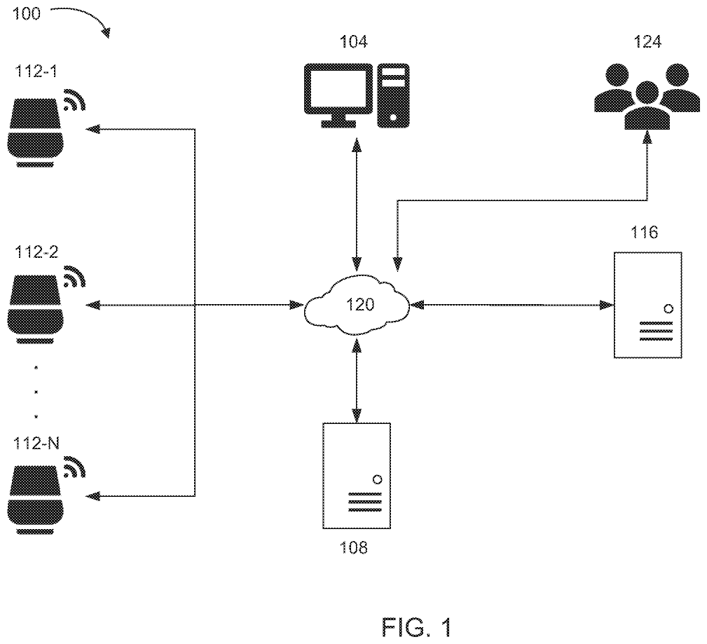

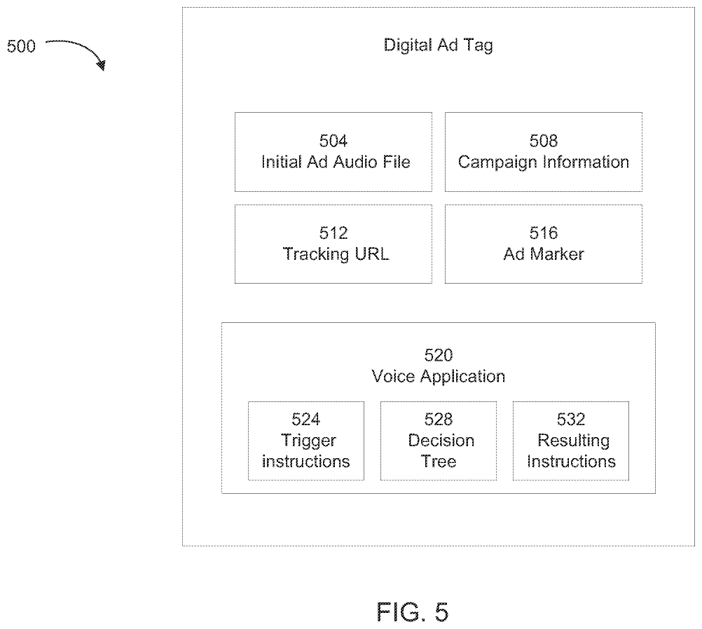

By way of general overview, there is provided a system and method of executing one or more digital ad tags with one or more embedded voice applications on a voice-enabled smart connection device. As shown in FIG. 5, a person skilled in the art will understand a digital advertisement tag or “digital ad tag” 500 to mean an Extensible Markup Language (XML) file either containing or pointing towards various data modules, including, but not limited to, audio files, campaign information and programming to determine the behavior of the interactive audio ad when interacting with listeners and consumers, stored on server 108 (see FIG. 1), where, when the digital ad tag is executed by smart connected device 112 (see FIG. 1), constitutes a component of or a link to an interactive advertisement or “interactive ad”. A person skilled in the art will understand that an interactive ad may comprise audio content, video content or both. Interactive ads are design to encourage consumer participation. A person skilled in the relevant art will understand that an interactive ad includes a digital ad tag as software code (e.g. XML). Digital ad tags may include modules to allow tracked statistics to be sent to analytics servers, campaign information and also embedded voice applications. Embedded voice applications may include references to the audio played in voice-enabled smart connection devices, and decision trees that dictate the behaviour of an interactive audio when receiving responses from listeners and consumers from the voice-enabled smart connection device. A person skilled in the art will understand that an interactive ad (also referred to herein as a digital interactive ad) interacts with a listener or consumers and may receive inputs from the listener or the consumer. This will be further explained below. The advantage of the system as described below is to provide listeners or consumers of voice-enabled smart connection devices the ability to verbally respond to interactive ads seamlessly and allow for follow up actions depending on the response from the listener or consumer. Furthermore, digital ad tags with embedded voice applications may be created without the need for creating custom software, or the need for a software developer to do so. In addition, the systems and methods of the presents invention have the added advantage of being modular, allowing for components of interactive ads and/or digital ad tags to be modified and added easily. This modularity allows for the quick modification of components of interactive ads and/or digital ad tags (e.g. voice applications) after they have been analyzed for their effectiveness and listener adoption (e.g. degree of interaction to the tag by the consumer), ensuring that there may be minimal lost time before a newly optimized advertisement/digital ad tag may be used. In addition, the modularity and ease of use allows for a creator (also referred to herein as an ad creator or ad developer) of such interactive ads/digital ad tags that may not be an experienced software developer, to modify the interactive ad/digital ad tag.

By taking the information from the digital ad tag, the information associated with the smart connected device, and the data arising from the interaction between the ad consumer or listener with the smart connected device, analytics may be used to determine the effectiveness of the digital ad tag contained with in or as part of the interactive ad.

FIG. 1 depicts an example system 100 for creating and updating digital ad tags with embedded voice applications, and for voice-enabled smart connected devices to execute said digital ad tags. System 100 includes voice-enabled smart connected devices 112-1, 112-2 . . . 112-N. (Voice-enabled smart connected devices are referred to here generically as voice-enabled smart connected device 112 and collectively as voice-enabled smart connected devices 112. This nomenclature is used elsewhere herein.) System 100 further includes client terminal 104, ad server 108 (also referred to herein as digital ad server 108), analytics server 116, certifiers 124 and wireless access network 120.

Smart connected devices 112, client terminal 104, ad server 108, ad server 116 and certifiers 124 may all be interconnected via wireless access network 120. Creators may use client terminal 104 to access a plugin or a user interface to create or update a digital ad tag. The resources and processing to create or update the digital ad tag reside on ad server 108. A voice application to be embedded within digital ad tag may be created on client terminal 104 and stored on ad server 108. Voice applications require certification before being embedded into the digital ad tag, and may be submitted to certifiers 124 for certification, as noted below. Once certified, ad server 108 may embed the voice application in the digital ad tag. Digital ad tags may then be registered with analytics server 116 to gather statistics regarding the digital ad tag, while being executed on smart connected devices 112. Components of system 100 will be discussed further in detail below.

Smart connected devices 112, client terminal 104, ad server 108, and analytics server 116 may be implemented with computer systems which are well known in the art. Generally speaking, computers include a central processor, system memory, and a system bus that couples various system components (typically provided on cards), including the system memory, to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (BIOS) stored in a read only memory (ROM) and one or more program modules such as operating systems, application programs and program data stored in random access memory (RAM). Computers may also include a variety of interface units and drives for reading and writing data. A creator, or member can interact with computer with a variety of input devices, all of which are known to a person skilled in the relevant art. Computers can operate in a networked environment using logical connections to one or more remote computers or other devices, such as a server, a router, a network personal computer, a peer device or other common network node, a wireless telephone or wireless personal digital assistant.

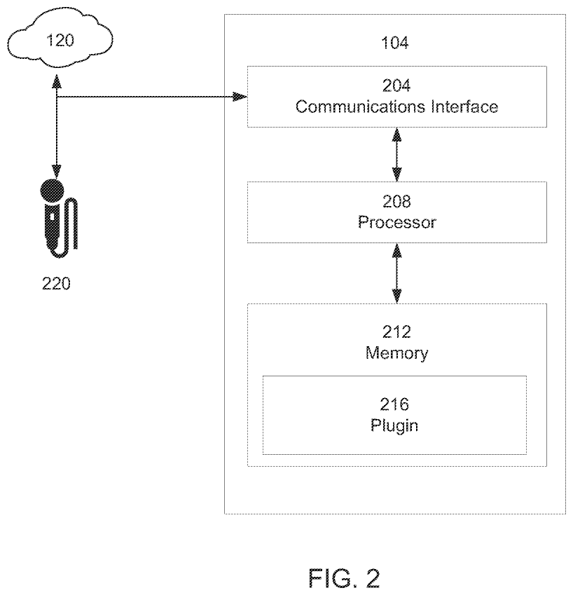

FIG. 2 shows a preferred embodiment of client terminal 104. Client terminal 104 may include a processor 208 interconnecting a memory 212 and a communications interface 204. Processor 208 can include a central-processing unit (CPU), a microcontroller, a microprocessor, a processing core, a field-programmable gate array (FPGA), or similar. Processor 208 can include multiple cooperating processors. Processor 208 can cooperate with non-transitory computer readable medium, such as memory 212 to execute instructions to realize the functionality discussed herein.

As shown in FIG. 2, memory 212 can include a combination of volatile (e.g. Random Access Memory or RAM) and non-volatile memory (e.g. non-volatile random-access memory, read only memory or ROM, electrically erasable programmable read only memory or EEPROM, flash memory). All or some of memory 212 may be integrated with processor 208. Memory 212 stores computer readable instructions for execution by processor 208.

In particular, memory 212 stores a plurality of computer-readable data and programming instructions, accessible by processor 208, in the form of software objects, such as various applications, queries or types of data for use during the execution of those applications. In particular, the execution of the instructions in memory 212 by processor 208 allow for access to a user interface to create or update digital ad tags. Furthermore, the execution of the instructions in memory 212 by processor 208 provide the creator the ability to create new voice dialogue for the voice application to be embedded in the digital ad tag. A person skilled in the art will now recognize that various forms of computer-readable programming instructions stored in memory 212 can be executed by processor 208 as applications.

Memory 212 further stores plugin 216, which can aid a creator in creating voice dialogue for the voice application to be embedded in the digital ad tag. Plugin 216 connects to ad server 108 and provides an interface for the creator to record and manipulate voice dialogue, and further provides the ability to embed voice dialogue as part of a voice application by manipulating the XML structure of the digital ad tag. In alternate embodiments, plugin 216 connects to ad server 108 via an application programming interface (“API”), allowing a creator to perform functions associated with ad server 108, such as creating the voice application, browsing through voice application templates, and editing existing voice application templates. The functions of ad server 108 and the process of building the voice application and embedding it into the digital ad tag will be discussed further below.

As shown in FIG. 2, client terminal 104 further includes communications interface 204. Communications interface 204 allows for processor 208 to communicate with wireless access network 120. Communications interface 204 includes suitable hardware (e.g. transmitters, receivers, network interface controllers and the like) allowing client terminal 104 to communication with other components in system 100, such as ad server 108. The specific components of communications interface 204 may be selected based on the type of network or other links that client terminal 104 may be required to communication over.

Client terminal 104 can also include input devices that connect to processor 208, such as a keyboard and mouse, as well as output devices, such as a display. Alternatively, or in addition, the input and output devices can be connected to processor 208 via communications interface 204 via another computer device. In other words, input and output devices can be local to client terminal 104 or remote. In the present embodiment, audio input device 220 may be an example of an input device connected to processor 208 in client terminal 104 via communications interface 204. Audio input device 220 may be used to provide audio input to client terminal 104 for the purpose of creating a voice dialogue or a sound file for the voice application. Audio input device 220 may include microphones, amplifiers, electronic instruments, or other audio generating devices where the audio may be provided to processor 208 as an electronic sound file. A person skilled in the art will now recognize the availability of different input and output devices and that there are a variety of methods of connecting to processor 208. In addition, a person skilled in the art will further recognize the availability of different audio input devices to provide processor 208 in client terminal 104 with audio.

Client terminal 104 can be a computer device such as, but not limited to, a desktop computer, a laptop computer, another server, a kiosk, a cell phone, a tablet, a mobile device, a monitor or other suitable device. A person skilled in the art will also appreciate that other, different configurations of client terminal 104 are contemplated. For example, client terminal 104 combined with audio input device 220 could be implemented as a tablet or a mobile device with either a build in or external synthesizer.

Returning to FIG. 1, client terminal 104 may be connected to ad server 108 via wireless access network 120. As previously indicated, a ad/ad tag creator may access ad server 108 via wireless access network 120 through plugin 216.

Ad server 108 may be used for the purpose of creating or updating digital ad tags, and the storage of voice application templates. Client terminal 104 may use plugin 216 as a user interface to ad server 108 to manipulate digital ad tags. It will occur to a person skilled in the art that ad server 108 may not be limited to only a single server or memory storage, but may be multiple discrete servers and memory storages.

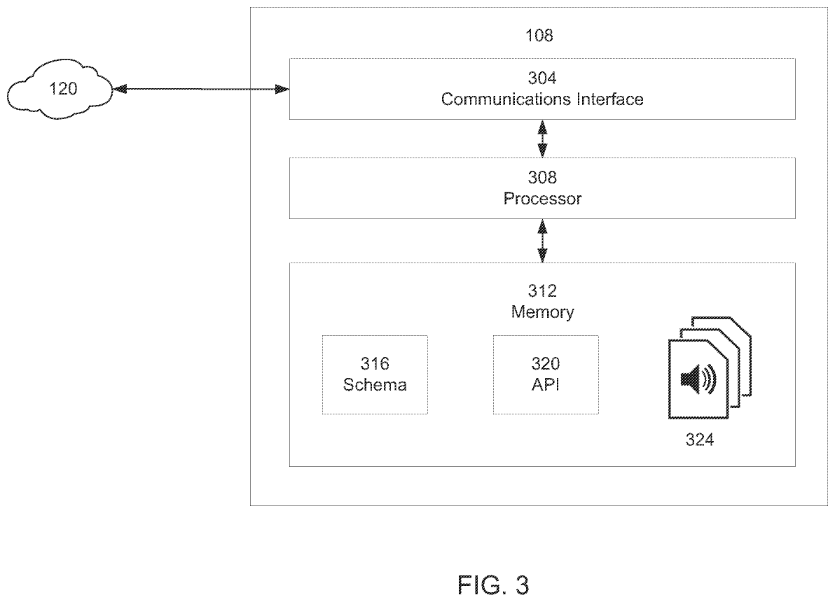

FIG. 3 shows a preferred embodiment of ad server 108. Ad server 108 may include a processor 308 interconnecting a memory 312 and a communications interface 304. Similar to processor 208 of client terminal 104, processor 308 can include a central-processing unit (CPU), a microcontroller, a microprocessor, a processing core, a field-programmable gate array (FPGA), or similar. Processor 308 can include multiple cooperating processors. Processor 308 can cooperate with non-transitory computer readable medium, such as memory 312 to execute instructions to realize the functionality discussed herein.

Similar to memory 212, memory 312 can include a combination of volatile (e.g. Random Access Memory or RAM) and non-volatile memory (e.g. non-volatile random-access memory, read only memory or ROM, electrically erasable programmable read only memory or EEPROM, flash memory). All or some of memory 312 may be integrated with processor 308. Memory 312 stores computer readable instructions for execution by processor 308.

In particular, memory 312 stores a plurality of computer-readable data and programming instructions, accessible by processor 308, in the form of software objects, such as various applications, queries or types of data for use during the execution of those applications. In particular, the execution of the instructions in memory 312 by processor 308 allows for the creation of a digital ad tag through interaction of a creator with a user interface. In addition, the execution of the instructions in memory 312 by processor 308 allows for the embedding of a voice application as part of the digital ad tag. A person skilled in the art will now recognize that various forms of computer-readable programming instructions stored in memory 312 can be executed by processor 308 as applications.

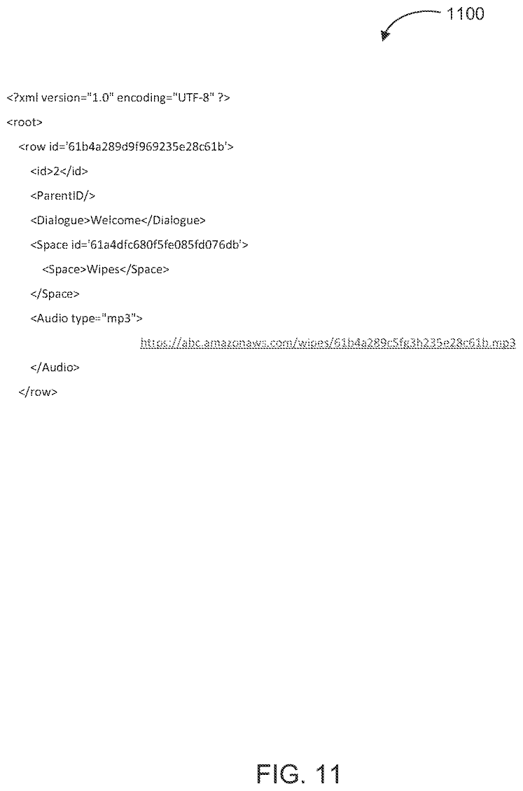

Memory 312 further includes schema 316. Schema 316 acts as the XML template to create a digital ad tag. More specifically, schema 316 provides the XML template for the Video Ad Serving Template (“VAST”) standard and the Digital Audio Ad Serving Template (“DAAST”). FIG. 11 shows an example of a portion 1100 of schema 316, where schema 316 points towards an Moving Pictures Experts Group Layer-3 Audio (MP3) audio file hosted externally to be used as the welcome message. Other examples include portions of schema 316 for identifying negative responses, or providing audio files for positive response. A person skilled in the art will recognize the different functions for schema 316.

Memory 312 also includes API 320. API 320 allows for plugin 216 on client terminal 104 to request and perform actions on ad server 108. More specifically, the interactions between plugin 216 and API 320 may further include, but are not limited to, allowing a creator through plugin 216 to create a voice application, edit the contents of the voice application, view and listen to pre-existing templates of voice applications, associate new voice dialogues to new or existing voice applications, configure templates of voice applications for custom use, saving new templates, submitting voice applications for certification, embedding the voice application into a digital ad tag, registering the digital ad tag with analytics server 116, customizing the digital ad tag, accessing engagement analytics, and requesting administrating and optimization functions, such as A/B testing based on the time of day or providing additional semantic, demographic, and contextual input to the voice application. For example, a ad or ad tag creator may record a voice dialogue on client terminal 104, and wish to upload it for the purposes of creating a voice application. While the recording may be performed on client terminal 104, plugin 216 may upload the recorded voice dialogue onto ad server 108, and interact with API 320 to embed it into a voice application. In another example, plugin 216 may communicate with API 320 to edit the contents of a digital ad tag before deploying it to be used on smart connected devices 112. Alternatively, a creator may also use plugin 216 and API 320 to register a digital ad tag with analytics server 116. A person skilled in the art will recognize the potential different functionality that API 320 may provide users through plugin 216.

Memory 312 may further includes templated voice applications 324. Templated voice applications 324 includes previously used voice applications that may be reviewed by ad or ad tag creators. Not only do templated voice applications 324 provide potential guidance to ad or ad tag creators creating new voice applications, but templated voice applications 324 may also act as a framework upon which they may alter the templated voice applications 324 to create their own voice applications. For example, a templated voice application 324 may have been used as part of a digital ad tag for a brand of laundry detergent pods. If an ad creator were trying to create a voice application for a brand of dishwashing detergent pods, the templated voice application 324 may provide a good framework to the ad creator to alter into their own voice application. Voice applications may also be saved by ad creators as templated voice applications 324 for future use by either the same ad creators, or for other ad creators to use.

Ad server 108 further includes communications interface 304. Similar to communications interface 204, communications interface 304 allows for processor 308 to communicate with wireless access network 120. Communications interface 304 includes suitable hardware (e.g. transmitters, receivers, network interface controllers and the like) allowing ad server 108 to communicate with other components in system 100, such as client terminal 104 and analytics server 116. The specific components of communications interface 304 may be selected based on the type of network or other links that ad server 108 may be required to communication over.

Returning to FIG. 1, once voice applications are created, they may need to be “certified”. Certification refers to the process whereby the interactive ad is certified to properly execute of smart devices, and to comply with end user license agreements of each smart device, as well as any broadcasting standards that may need to be adhered to. Certifiers 124 may certify and approve voice applications to be used in digital ad tags on smart connected devices 112. More specifically, certifiers 124 may be smart connected device 112 manufacturers, whose smart connected devices 112 execute the digital ad tag with the embedded voice application. As the manufacturers of said smart connected devices 112, certifiers 124 need to ensure that the voice application adhere to end user license agreements and any other contractual obligations that they may be party to. Examples of certifiers 124 include, but are not limited to corporations, such as Google, Amazon and Apple. Voice applications may be submitted to certifiers 124 from ad server 108 over wireless access network 120. Once a voice application has been approved, ad server 108 will receive approval from certifier 124. If an ad or ad tag creator wishes to use a voice application on a digital ad tag on multiple smart connected devices 112 manufactured by different companies, the voice application will require certification from each respective certifier 124.

System 100 further includes analytics server 116. Analytics server 116 may be used to gather statistics and analytics of the digital ad tags as they are executed on smart connected devices 112. As voice applications are certified and are embedded into digital ad tags, and as the digital ad tags are published to be used and executed by smart connected devices 112, the digital ad tags may also be registered with analytics server 116. By registering the digital ad tags with analytics server 116, analytics server 116 will recognize the digital ad tag when receiving statistics and analytics from smart connected devices 112 when the digital ad tags are being executed. Details regarding the statistics and analytics and the type of data being recorded will be discussed further below.

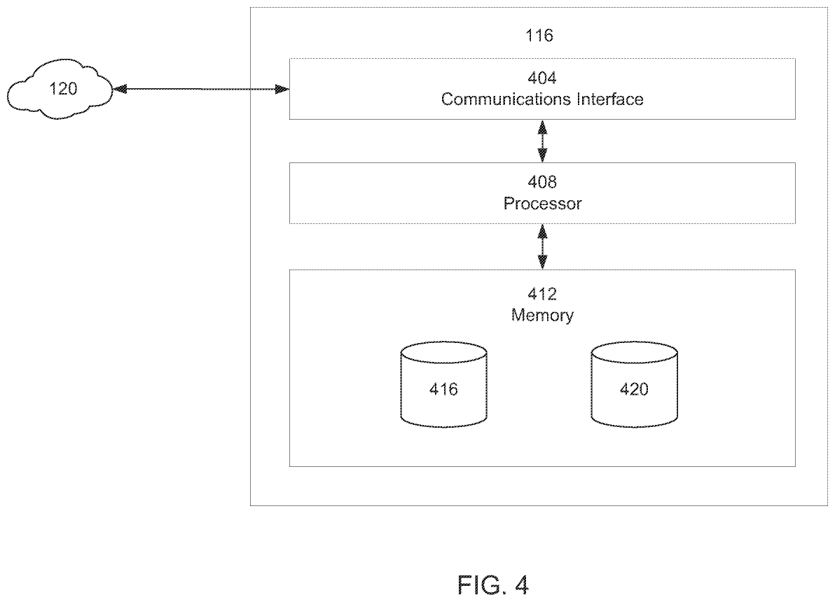

FIG. 4 shows the preferred embodiment of analytics server 116. Analytics server 116 may include a processor 408 interconnecting a memory 412 and a communications interface 404. Similar to processor 208 and processor 308 of client terminal 104 and ad server 108 respectively, processor 408 can include a central-processing unit (CPU), a microcontroller, a microprocessor, a processing core, a field-programmable gate array (FPGA), or similar. Processor 408 can include multiple cooperating processors. Processor 408 can cooperate with non-transitory computer readable medium, such as memory 412 to execute instructions to realize the functionality discussed herein.

Similar to memory 212 and memory 312, memory 412 can include a combination of volatile (e.g. Random Access Memory or RAM) and non-volatile memory (e.g. non-volatile random-access memory, read only memory or ROM, electrically erasable programmable read only memory or EEPROM, flash memory). All or some of memory 412 may be integrated with processor 408. Memory 412 stores computer readable instructions for execution by processor 408.

In particular, memory 412 stores a plurality of computer-readable data and programming instructions, accessible by processor 408, in the form of software objects, such as various applications, queries or types of data for use during the execution of those applications. In particular, the execution of the instructions in memory 412 by processor 408 allow for the recording of data pertaining to the instances of execution of digital ad tags and their embedded voice applications. Furthermore, execution of the instructions in memory 412 by processor 408 also allows for the query of data from databases that contain data pertaining to the instances of execution of digital ad tags and their embedded voice applications.

Storage of data pertaining to the instances of execution of digital ad tags and their embedded voice applications occurs in databases 416 and 420 in memory 412. More specifically, database 416 stores digital ad tag instance data and database 420 stores voice application instance data. Digital ad tag instance data includes data that may be associated with the execution of the digital ad tag by smart connected device 112, including, but not limited to the IP address or identifier of the smart connected device 112, any hardware identifiers and the device type of the smart connected device 112, the corresponding voice application identifier being executed as part of the execution of the digital ad tag, the contextual information about the content of the digital ad tag, a campaign identifier of the advertising or marketing campaign that the digital ad tag may be part of, any demographic information pertaining to the demographic that the digital ad tag may be targeting and the location of smart connected device 112.

Voice application instance data includes that may be associated with the voice application itself, including, but not limited to, the questions posed or other provided to the consumer from smart connected device 112, the answers provided by the consumer and received by smart connected device 112, an identifier for the digital ad tag that matches the registration of the digital ad tag with the analytics database and an identifier of the voice application. A person skilled in the art will recognize the different variables and statistics that may be gathered as digital ad tag instance data and voice application instance data.

By recording the digital ad tag instance data and the voice application instance data, queries can be performed on databases 416 and 420 individually or by cross-referencing the data across both databases 416 and 420. This allows for the analysis of the data to determine the success of a digital ad tag, or the engagement of the population (e.g. consumers) in response to the digital ad tag, along with whether particular voice applications may be more successful over others when advertising for particular industries. It also allows for the determination of engagement with specific brands using the digital ad tag. A person skilled in the art will recognize the different queries that can be applied to the digital ad tag instance data and the voice application instance data in databases 416 and 420 to determine the effectiveness of an advertising campaign, branding and its associated digital ad tags.

In the current embodiment, databases 416 and 420 are split based on digital ad tag instance data and voice application instance data. However, in other embodiments, databases 416 and 420 may be a single database in memory 412, or may be split into multiple databases across different analytics servers 116. A person skilled in the art will recognize the different configurations possible for the recording of analytics pertaining to the execution of digital ad tags with embedded voice applications on smart connected devices 112.

Analytics server 116 further includes communications interface 404. Similar to communications interface 204 and communications interface 304, communications 404 allows for processor 408 to communicate with wireless access network 120. Communications interface 404 includes suitable hardware (e.g. transmitters, receivers, network interface controllers and the like) allowing analytics server 116 to communicate with other components in system 100. The specific components of communications interface 404 may be selected based on the type of network or other links that analytics server 116 may be required to communicate over. For example, analytics server 116 may be accessed by other client terminals (not depicted) to run queries and access the data from databases 416 and 420.

Returning to FIG. 1, smart connected devices 112 may access a digital ad tag on ad server 108 and execute the digital ad tag. The execution of a digital ad tag may occur due to an ad marker trigger, such as based on a sound that may be detected, or as part of a pre-programmed broadcast. The ad marker trigger will be further discussed below.

Voice-enabled smart connected devices 112, also referred to herein as smart connected devices 112, are connected to input devices (not shown) to allow interaction with ad consumers, listeners, etc. when executing a digital ad tag 500. When a digital ad tag 500 is executed, the input devices that may be connected to smart connected devices 112 receive input from the consumer of the smart connected devices 112. Examples of input devices include, but are not limited to, a keyboard, a mouse, a touch screen and a microphone (also referred to as an audio input device). Smart connected devices 112 may also be connected to output devices (not shown), such as a monitor, a display, or speakers. For example, smart connected device 112 may include smart speakers, televisions, mobile devices or any device that has an audio output to be able to play the voice dialogue of a voice application. In a preferred embodiment, smart connected devices 112 would also have an audio input, such as a microphone, to pick up responses from a consumer/listener (also referred to herein as listener inputs), and would contain the ability to use natural language processing. An example of this would be a smart speaker with Google assistant, or an Apple mobile device with Sid. The natural language processing would allow smart connected device 112 to pick up responses from consumer/listener, and allow for the processing of voice applications. Without an audio input component and natural language processing, a voice application cannot be executed. The components of a voice application will be discussed further below. Different input and output devices and a variety of methods of connection to smart connected device 112, either locally or remotely, may be used. A person skilled in the art will recognize the different input and output devices that may be connected to smart connected devices 112.

Smart connected devices 112, client terminal 104, ad server 108, and analytics server 116 may include a network interface that couples the system bus to wireless access network (“WAN”) 120, also referred to herein as WAN 120. WAN 120 is an example implementation of the connection between components in system 100, and a person skilled in the art will recognize that WAN 120 is not particularly limited in its configuration. Wireless access network 120 may be any form of network, including a local area network (LAN), or the Internet, and may be accessed by said computers or mobile devices. Computers, such as smart connected devices 112, client terminal 104, ad server 108, and analytics server 116 can operate in a networked environment using logical connections to one or more remote computers or other devices, such as a server, a router, a network personal computer, a peer device or other common network node, a wireless telephone or wireless personal digital assistant. In the current embodiment, WAN 120 may be implemented over the Internet. The standards or protocols used for the network may include any form of transmission, such as Transmission Control Protocol/Internet Protocol (TCP/IP), User Datagram Protocol/Internet Protocol (UDP/IP), Hyper Text Markup Language (HTML) and Hyper Text Transfer Protocol (HTTP). In addition, any desired levels and types of security and encryption protocols are contemplated and can be implemented over WAN 120. A person skilled in the art will recognize the different potential network types and different potential network configurations that may be used, along with the different standards and protocols of transmission within the network, and the different forms of security and encryption protocols available.

FIG. 5 shows a preferred embodiment of digital ad tag 500. Digital ad tag 500 may include initial ad audio file 504, campaign information 508, tracking URL 512, ad marker 516 and voice application 520. Each of the aforementioned components in digital ad tag 500 may be considered to be XML modules of schema 316, or may be considered to be XML modules of schema 316 that direct smart connected device 112 to an external address to retrieve a file, application or payload for execution, and will be further described below. As previously indicated, the XML modules of schema 316 may adhere to a VAST standard or a DAAST standard, and as such, digital ad tag 500 conforms to the same standards.

Initial ad audio file 504 is the audio file that first plays when digital ad tag 500 is first invoked or initiated to be executed on smart connected device. The initiation of digital ad tag is triggered by ad marker 516 and will be further described below. Once digital ad tag 500 is initiated, initial ad audio file 504 may be played on smart connected device 112 for the consumer or listener. Initial ad audio file 504 may be any audio file that is compatible with smart connected device 112, including, but not limited to way files or mp3 files. In the current embodiment, initial ad audio file 504 may be an audio file that is stored on ad server 108, where the XML module on schema 316 for executing the initial ad audio file 504 may instruct smart connected device 112 to stream or retrieve the initial ad audio file 504 by directing smart connected device 112 to an address on ad server 108 to play as an audio output on smart connected device 112. For example, if digital ad tag 500 was for the advertisement of laundry detergent pods, initial ad audio file 504 may be “Brand X of laundry detergent pods are the best! Would you like to hear more about brand X laundry detergent pods?” This audio file may be stored in ad server 108, and smart connected device 112 may play the audio file on its speakers to the listener or consumer by streaming it from ad server 108 based on the address in the XML module.

Digital ad tag 500 also includes campaign information 508, which provides an identifier, as well as potentially information pertaining to the advertisement campaign or marketing campaign that digital ad tag 500 may be related to. Campaign information 508 may either be directly embedded into the XML module of schema 316, or alternatively, an identifier for a specific campaign may be placed as a pointer, directing smart connected device 112 to an external database with additional information pertaining to the campaign. For example, campaign information 508 may be “Brand X Laundry Detergent Pods launch”. Alternatively, campaign information 508 may be a pointer directing smart connected device 112 to look at a database that provides additional information pertaining to the Brand X's laundry detergent pod campaign, such as the launch date of the campaign.

Campaign information 508 may not be limited to a direct relationship with digital ad tag 500. More specifically, advertising campaigns or marketing campaigns may include more than one digital ad tag 500. For example, there may be several brand X laundry detergent pod digital ad tags 500 over the course of a year, all of which may call under the same advertising campaign. As such, campaign information 508 may not have a one-to-one relationship with each digital ad tag 500, but may have a one-to-many relationship with each digital ad tag 500. A person skilled in the art will recognize that while in the current embodiment there is a structure of digital ad tags 500 falling within campaigns, it is not limited to only a single categorical division, but where digital ad tags 500 may be subdivided based on other attributes, such as branding, and a person skilled in the art will recognize said other attributes.

Digital ad tag 500 also includes tracking URL 512. Tracking URL 512 provides a link to analytics server 116, and upon execution of tracking URL 512 by smart connected device 112, digital ad tag instance data and voice application instance data may be sent to analytics server 116. In alternative embodiments, upon execution of tracking URL 512, the unique identifier of digital ad tag 500 may be sent by smart connected device 112 to analytics server 116, where analytics server 116 may request the additional information from smart connected device 112. Tracking URL 512 may be activated after execution of voice application 520 by smart connected device 112. As such, data collected as part of the execution of voice application 520 may be stored as voice application instance data in database 420 in analytics server 116.

Digital ad tag 500 further includes ad marker 516. Ad marker 516 provides a trigger condition for the execution of digital ad tag 500, and may be placed in a media stream. For example, smart connected device 112 may be playing a video. Ad marker 516 may be placed within the timeline of the video. As soon as smart connected device 112 detects ad market 516 while playing the video, smart connected device 112 may be triggered to execute digital ad tag 500. Alternatively, ad marker 516 may be triggered through the use of a digital assistant, or by the microphone of smart connected device 112 recording audio that may be part of the conditions to execute digital ad tag 500. For example, if smart connected device 112 with a digital assistant were asked about laundry detergent pods, then ad market 516 may trigger smart connected device 112 to execute digital ad tag 500. Alternatively, if smart connected device 112 heard an advertisement on television regarding brand X laundry detergent pods, then smart connected device 112 may trigger smart connected device 112 to execute digital ad tag 500.

Digital ad tag 500 also includes voice application 520. Voice application 520 includes trigger instructions 524, decision tree 528 and resulting instructions 532. In the current embodiment, voice application 520 and all of its components, trigger instructions 524, decision tree 528 and resulting instructions 532 may reside on ad server 108, where schema 316 may have an XML module pointing towards the files and components of voice application 520 to be executed on smart connected device 112. In alternative embodiments, voice application 520 and all of its components may reside part of the XML module to be executed locally on smart connected device 112. The execution of voice application 520 requires that smart connected device 112 include an audio input component, such as a microphone, and natural language processing in order for a listener or consumer to interact with voice application 520. If smart connected device 112 does not include an audio input component and natural language processing, smart connected device 112 will only be able to play initial ad audio file 504, before the execution of digital ad tag 500 stops. This is due to the fact that voice application 520 requires interaction from the listener or consumer to initiate trigger instructions 524 and to navigate decision tree 528.

Trigger instructions 524 are the expected responses to indicate that a consumer or listener wishes to proceed with executing voice application 520 and more specifically the execution of decision tree 528. In a previously discussed example, where an initial ad audio file 504 included playing “Brand X of laundry detergent pods are the best! Would you like to hear more about brand X laundry detergent pods?”, trigger instructions 524 may be providing an affirmative response to initial ad audio file 504, such as, for example, “Yes”.

Natural language processing within smart connected device 112 allows for trigger instructions 524 to be broader than the receipt of a single word from a listener or consumer, such as the word “Yes”, allowing for affirmative responses in generally, such as “Yep”, “Ya” or “Yes I would”. Similarly, natural language processing allows for the interpretation of negative responses as well, such as “No” or “Nope”, allowing the listener or consumer to indicate not to continue with the execution of voice application 520.

In the event of a consumer or listener failing to meet the trigger conditions of trigger instructions 524, such as providing a negative response, or not providing a response at all, smart connected device 112 will not execute the remainder of decision tree 528 from voice application 520. Resulting instructions 532 will also not be executed. Tracking URL 512 may then be activated, after which the execution of digital ad tag 500 by smart connected device 112 is complete. In the event of a listener or consumer meeting the trigger conditions of trigger instructions 524, such as providing an affirmative response, smart connected device 112 will continue to execute voice application 520. Both of these processes will be further discussed below.

Voice application 520 also includes decision tree 528. Decision tree 528 is an application or a set of logical rules that may be similar to a flow chart. As previously indicated, the functionality of plugin 216 may provide a user interface to ad server 108 to allow an ad creator to create or update a digital ad tag. The creation and updating of a digital ad tag includes the creation of voice application 520 and decision tree 528. When creating decision tree 528, the user interface of plugin 216 depicts a flow chart, where an ad creator may provide voice dialogue in response to various listener or consumer responses. Each block within the decision tree 528 is representative of a block of XML code that may be part of the creation of voice application 520. For example, if an audio file needs to be played as part of voice application 520, the user interface may allow an ad creator to add a block to play an audio file, where the block may have a text field to allow the ad creator to indicate the location of the audio file to be played. In another example, a decision block may be added to await input from the smart connected device 112, and in the event of a negative response, to perform specific actions, or in the event of a positive response, to perform other actions. Accordingly, XML code may be added to voice application 520 depending on the details of the blocks as provided through the user interface. A person skilled in the art will recognize the different combinations, configurations, and functions of the blocks, and how they may provide a user interface for ad creators to further provide XML code for the behaviour and actions of voice application 520.

Voice application 520 further includes resulting instructions 532. Resulting instructions 532 is the action that may be triggered as a result of interaction between a listener or consumer and voice application 520. Voice application 520 may have a single resulting instruction 532 to be executed prior to the completion of the execution of voice application 520, or voice application 520 may have multiple resulting instructions 532, some of which may be executed during the execution of decision tree 528. For example, where decision tree 528 includes a final dialogue of “Would you like to order some brand X laundry detergent pods?” a response in the affirmative may trigger the resulting instructions 532 to place an order of laundry detergent pods in an electronic cart awaiting final purchase. Alternatively, another example of resulting instructions 532 may be if responding to a dialogue in the decision tree led to the creation of a reminder in a listener's calendar to purchase laundry detergent pods every month. A person skilled in the art will recognize the different possible resulting instructions 532 and the different configurations and arrangements of resulting instructions 532 and decision tree 528 for voice application 520 for advertising campaigns.

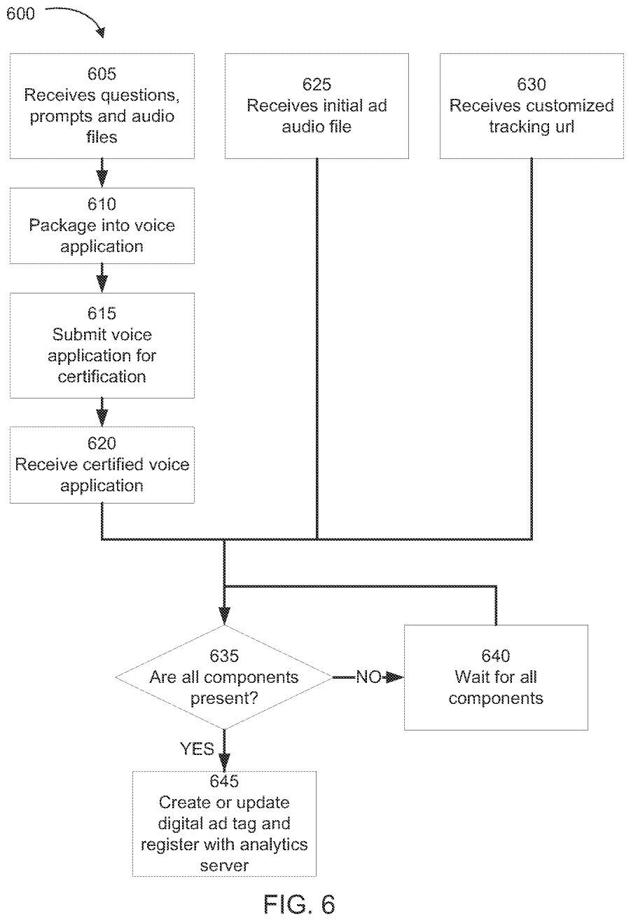

As previously stated, the creation of digital ad tag 500 may include using plugin 216 connected to ad server 108. FIG. 6 shows the preferred embodiment of method 600. Method 600 shows the process for creating or updating digital ad tag 500 on ad server 108.

At block 605, ad server 108 receives questions, prompts and audio files from the creator through plugin 216. Plugin 216 may provide a user interface for ad developers or ad creators to create their own voice application 520, by allowing ad developers or creators to create their own trigger instructions 524, decision tree 528 and resulting instructions 532. Ad creators may submit inputs to plugin 216, including questions, responses, prompts and audio files, such as voice dialogue recorded by audio input device 220, to create voice application 520. Once received by ad server 108, the inputs received from plugin 216 may be converted into XML and packaged into voice application 520. This is depicted at block 610.

At block 615, voice application 520 may be submitted to certifiers 124 for approval through WAN 120. Once approved, certification may be received through WAN 120 at ad server 108, as is depicted at block 620. Once voice application 520 has been approved or certified, it may be used as part of digital ad tag 500. An approved voice application 520 may also be saved on ad server 108 as a template for future use, or for future modification.

Concurrently, at block 625, while voice application 520 is being created, or while voice application 520 may be certified by certifiers 124, ad server 108 may also receive initial ad audio file 504 from an ad creator through plugin 216. Similar to the voice dialogue for voice application 520, initial ad audio file 504 may either be a pre-recorded audio file, or it may be recorded using audio input device 220 on client terminal 104, and then uploaded to ad server 108 via plugin 216.

In addition, at block 630, tracking URL 512 may be customized and received by ad server 108. Customizations may include the provision of consumers' or audiences' demographic information based on ad server parameters, contextual information of content the ad is played in, frequency of ad, and other macros (key value pairs) that a particular campaign may require.

While blocks 625 and 630 are depicted as occurring concurrently, they may occur in any sequency of events in relation to block 605. More specifically, block 625 may occur prior to block 605 or after block 605. Similarly, block 630 may occur prior to block 605 or after block 605.

At block 635, ad server 108 checks to see if all components for digital ad tag 500 are present. More specifically, processor 308 of ad server 108 will verify if certified voice application 520, initial ad audio file 504, tracking URL 512, campaign information 508 and ad marker 516 are received and present. If all components for digital ad tag 500 are not present, processor 308 of ad server 108 will continue to wait for the missing components as depicted at block 640. While not depicted, ad marker 516 and campaign information 508 may be also edited via plugin 216. If all components are present, then processor 308 may proceed to create or update digital ad tag 500 and register the digital ad tag 500 with analytics server 116.

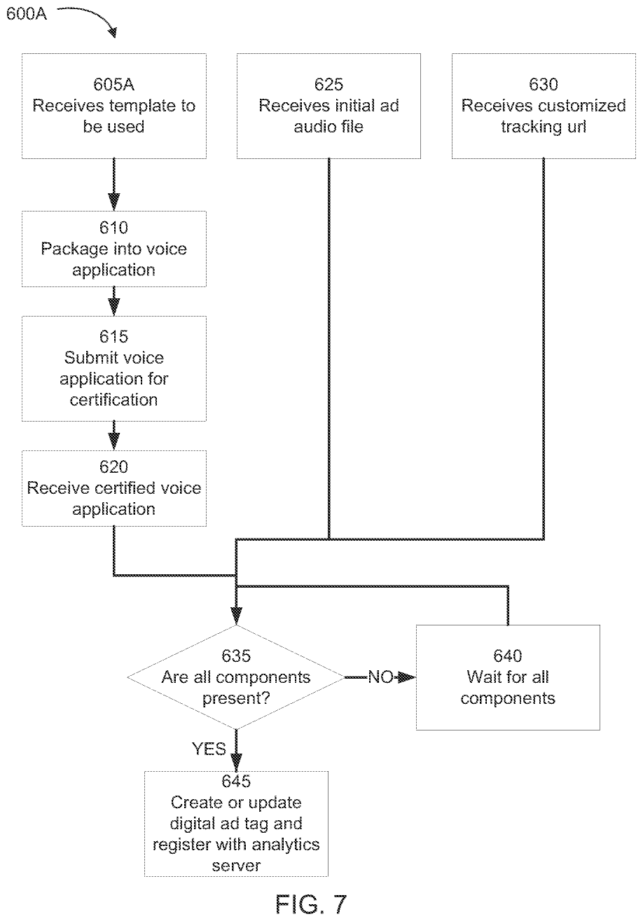

As previously stated, voice application 520 may be saved as a template on ad server 108. FIG. 7 shows an alternate embodiment method 600A. Method 600A shows the process for creating or updating digital ad tag 500 on ad server 108 using a previously saved template of voice application 520. At block 605A, a templated voice application 520 may be selected by an ad creator through plugin 216, and the selection may be received by ad server 108. In alternative embodiments, if templated voice application 520 was saved locally on client terminal 104, then templated voice application 520 may be uploaded through plugin 216 to ad server 108.

Components of templated voice application 520 may be modified to accommodate a new digital ad tag 500. For example, the voice dialogue in decision tree 528 may be changed, or resulting instructions 532 may be modified. Whether modified or not, voice application 520 will require to be approved or certified with certifiers 124 as depicted at blocks 615 and 620, where the templated or modified voice application 520 may be submitted to certifiers 124 and approval received at ad server 108.

The remaining steps of method 600A may be similar to method 600 of FIG. 6. More specifically, templated voice application 520, or voice application 520 that was modified from templated voice application 520 may be packaged into digital ad tag 500 once all components of digital ad tag 500 are received by ad server 108. A person skilled in the art will recognize the different methods and sequence of events that are available in creating or updating digital ad tag 500.

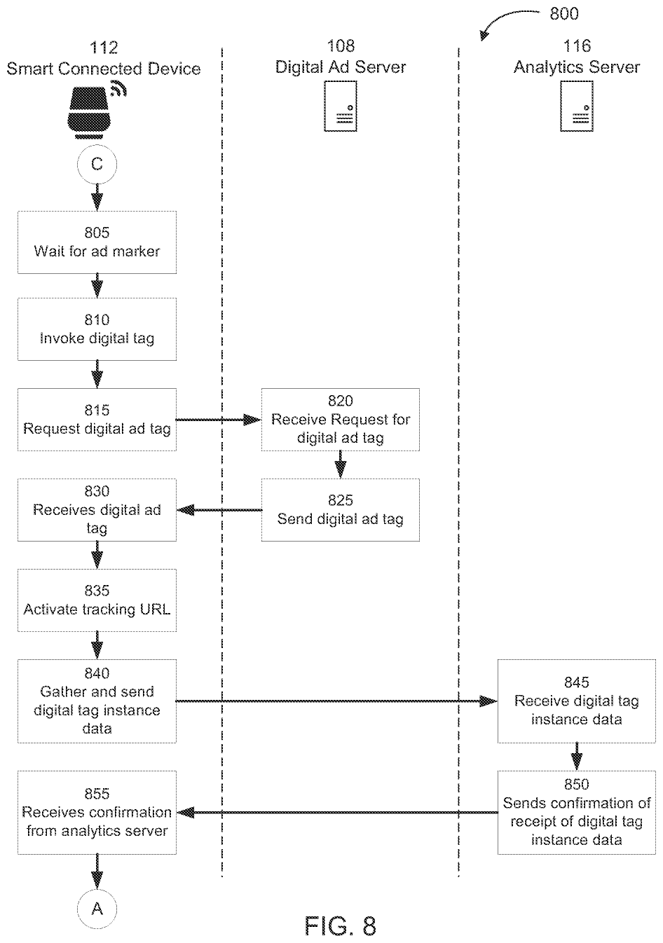

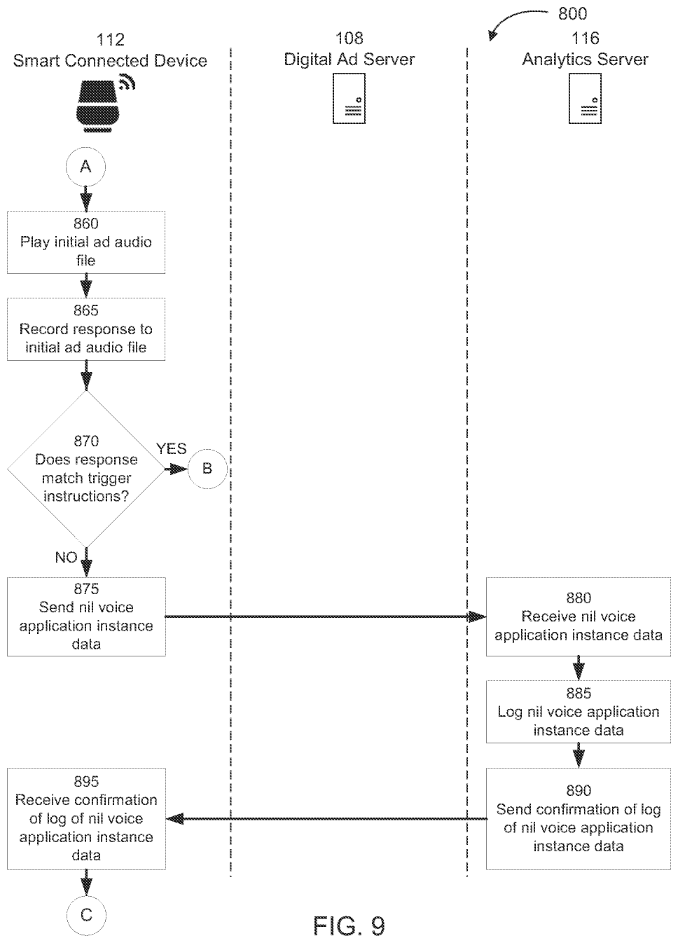

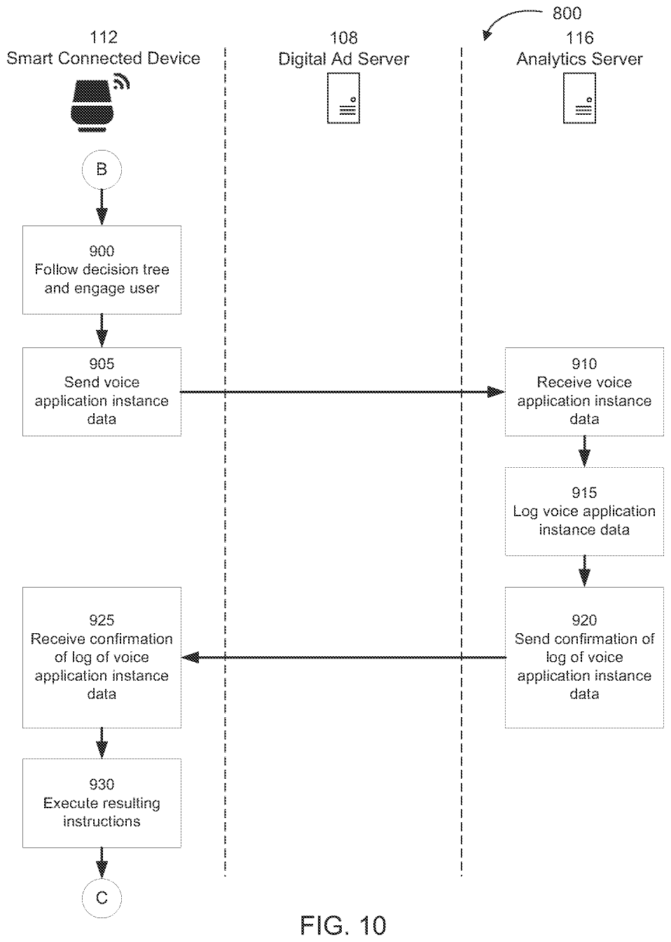

FIGS. 8, 9 and 10 show the preferred embodiment of method 800. Method 800 shows the process for executing digital ad tag 500 on system 100. More specifically, method 800 shows the interaction between smart connected device 112, ad server 108 and analytics server 116 when executing digital ad tag 500.

At block 805, smart connected device 112 may be playing media. While playing media, ad marker 516 may trigger smart connected device 112 to execute digital ad tag 500. This is depicted at block 810.

In order to complete the execution digital ad tag 500, voice application 520 of digital ad tag 500 may be required, and as such, at block 815 smart connected device 112 requests digital ad tag 500 and the components of digital ad tag 500, including voice application 520. Smart connected device 112, while executing the XML of digital ad tag 500 may be provided the instructions to request voice application 520 from ad server 108, and may be provided a pointer towards the specific voice application 520 to request. For example, the request to ad server 108 may include the ID associated with digital ad tag 500 or the ID associated with the voice application 520 being requested. Alternatively, a URL or other form of pointer may be provided to provide the correct identification of the requested voice application 520.

At block 820, ad server 108 receives the request for digital ad tag 500 and the components of digital ad tag 500. Upon receipt of the request for digital ad tag 500 and the components of digital ad tag 500, digital ad tag 500 and said components of digital ad tag 500 may be sent to smart connected device 112, as is depicted at block 825. At block 830, smart connected device 112 receives digital ad tag 500 and the components of digital ad tag 500 in preparation for execution.

At block 835, tracking URL 512 of digital ad tag 500 may be activated by smart connected device 112. This begins the process of gathering data for analytics server 116 pertaining to digital ad tag 500 and voice application 520. At block 840, smart connected device 112 gathers digital tag instance data and sends it to analytics server 116 through WAN 120. More specifically, the data related to digital ad tag 500, such as the IP address of smart connected device 112, hardware identifiers and the device type of smart connected device 112, and any demographic targeting information pertaining to digital ad tag 500 may be gathered and send to analytics server 116. The digital tag instance data that may be gathered and sent by smart connected device 112 may be received by analytics server 116, and stored in database 416. Once stored, confirmation of receipt and storage of digital tag instance data may be sent back to smart connected device 112 over WAN 120, where the confirmation may be received by smart connected device 112. This is depicted at blocks 850 and 855 respectively.

At block 860, smart connected device 112 plays initial ad audio file 504 on the audio output device of smart connected device 112. Initial ad audio file 504 may be played as a stream from ad server 108, or alternatively may be located locally on smart connected device 112 after retrieving the audio file from ad server 108. Alternatively, initial ad audio file 504 may be located on any server and be downloaded to be played or streamed on smart connected device 112. A person skilled in the art will recognize the different methods of obtaining and playing initial ad audio file 504, and the different potential sources for initial ad audio file 504.

At block 865, smart connected device 112 records the response to initial ad audio file 504, where the response may be part of the listener input received from the audio input device and/or microphone on smart connected device 112. Using natural language processing, the response may be analyzed and smart connected device 112 may determine whether the response matches that of trigger instructions 524 at block 870.

If the response does not match trigger instructions 524, nil voice application instance data may be sent to analytics server 116 via WAN 120. Alternatively, if there is no response, nil voice application instance data may also be sent to analytics server 116. Nil voice application instance data includes data pertaining to the response received and recorded by smart connected device 112 and data indicating that voice application 520 was not fully executed due to a failure of the response from the listener or consumer of the smart connected device 112 matching that of trigger instructions 524. This is depicted at block 875.

At block 880, analytics server 116 receives nil voice application instance data, and at block 885, nil voice application instance data may be logged in database 420. At block 890, analytics server 116 sends confirmation of receipt and logging of the nil voice application instance data via WAN 120, and at block 895, smart connected device 112 receives the confirmation. Once confirmation has been received by smart connected device 112, the execution of digital ad tag 500 is complete, and smart connected device 112 returns to waiting for ad marker 516 at block 805.

Returning to block 870, if the response received at smart connected device 112 after playing initial ad audio file 504 matches that of trigger instructions 524, smart connected device 112 executes the XML coding for decision tree 528. This is depicted at block 900. As previously indicated, executing decision tree 528 may include playing voice dialogues and recording responses to follow the logic in decision tree 528.

Upon the completion of execution of decision tree 528 at block 905, voice application instance data may be gathered and sent from smart connected device 112 to analytics server 116 via WAN 120. More specifically, the data related to voice application 520, such as the questions posed to listeners or consumers as part of decision tree 528 and the answers received from listeners or consumers in response to the questions posed may be gathered and sent to analytics server 116. The responses to the questions may also be considered to be part of the listener input received via audio input devices on smart connected device 112. The data associated with the listener inputs received, also referred to as the listener input data, may be part of the voice application instance data.

At block 910, voice application instance data may be received by analytics server 116. At block 915, voice application instance data may be logged into database 420, and at block 920, analytics server 116 sends confirmation of receiving and logging voice application instance data to smart connected device 112. Upon receipt of the confirmation, smart connected device 112 may execute resulting instructions 532. This is depicted at blocks 925 and 930.

After executing resulting instructions 532, smart connected device 112 returns to waiting for ad marker 516 at block 805, preparing itself to play the next digital ad tag 500.

While not depicted, in alternative embodiments, blocks 815 to 830 depicting the retrieval of voice application 520 may occur after the activation of tracking URL 512 at block 835, and the resulting gathering, receiving and confirmation of receipt of digital ad tag instance data represented by blocks 840 to 855. In addition, in alternative embodiments, the execution of resulting instructions 532 depicted at block 930 may occur prior to the sending, receiving and confirmation of voice application instance data as depicted at blocks 905 to 925. A person skilled in the art will recognize the different methods and sequence of operations possible for the execution of digital ad tag 500 and the gathering of data for analytics server 116.

In the above-mentioned embodiments, and alternate embodiments, the analytics for the interactive digital ad tags gathered may be used in determining the effectiveness and adoption rate of the interactive audio ad or digital ad tag being played or executed on smart connected device 112. The analytics gathered, which may include the digital tag instance data and/or the voice application instance data, may also be used in any other forms of analysis, analytics or analyzed through analytics processes, and may also be used to generate multiple outputs, such as reports. The analytics and reports may be considered useful for interactive audio ad designers and marketing professionals to determine how best to optimize and the deploy interactive audio ads or digital ad tags.

Although the foregoing description and accompanying drawings relate to specific preferred embodiments of the present invention as presently contemplated by the inventor, it will be understood that various changes, modifications and adaptations, may be made without departing from the spirit of the invention.

The invention claimed is:

1. A method of providing analytics for an interactive digital ad tag executed on a smart connected device, and gathering data regarding the execution of the digital ad tags for an analytics server, the method comprising:
receiving, by the smart connected device, the digital ad tag, the digital ad tag comprising a tracking uniform resource locator (URL), and a voice application, the digital ad tag received from a digital ad server;
activating the tracking URL, the tracking URL providing a link to the analytics server;
gathering and sending a digital tag instance data to the analytics server through the link;
executing the digital ad tags and receiving listener input as a voice application instance data to the smart connected device, the voice application instance data comprising listener input data; and
gathering and sending the voice application instance data to the analytics server through the link, wherein the digital tag instance data and voice application instance data is analysed through analytics processes.

2. The method of claim 1 further comprising performing a follow up action based on the listener inputs received.

3. The method of claim 1, wherein the digital ad tag further includes an ad marker, the method further comprising requesting the voice application from the digital ad server upon the ad marker being played on the smart connected device.

4. The method of claim 1, wherein the digital ad tag further comprises campaign information and audio files.

5. The method of claim 1, wherein the voice application comprises a decision tree, the decision tree comprising a set of logical rules for each digital ad tag.

6. A system of providing analytics for an interactive digital ad tag, executing the digital ad tag, and gathering data regarding the execution of the digital ad tag, each digital ad tag comprising a tracking uniform resource locator (URL) and a voice application, the system comprising:
an analytics server configured to receive a digital tag instance data and a voice application instance data, the analytics server comprising at least one database, the at least one database configured to store the digital tag instance data and the voice application instance data;
a digital ad server connected to said analytics server and configured to store the digital ad tag and the voice application; and
a smart connected device connected to said analytics server and said ad server, the smart connected device configured to:
receive a digital ad tag from the digital ad server;
activate the tracking URL, the tracking URL providing a link to the analytics server;
gather and send the digital tag instance data to the analytics server through the link;
execute the digital ad tag and receive listener inputs as a voice application instance data to the smart connected device, the voice application instance data comprising listener input data; and
gather and send the voice application instance data to the analytics server through the link to be analysed.

7. The system of claim 6, wherein the smart connected device is further configured to perform a follow up action based on a received listener input.

8. The system of claim 6, wherein the digital ad tag further includes an ad marker, and wherein the smart connected device is further configured to request the voice application from the digital ad server upon the ad marker being played on the plurality of smart connected devices.

9. The system of claim 6, wherein the digital ad tag further comprises campaign information and audio files.

10. The system of claim 6, wherein the voice application comprises a decision tree, the decision tree comprising a set of logical rules for the digital ad tag.
